(19) United States
(12) Patent Application Publication
(10) Pub. No.: US 2015/0292058 A1
(43) Pub. Date: Oct. 15, 2015

(54) METHOD FOR RECOVERING INDIUM FROM INDIUM CONTAINING SOLUTION OR MIXTURE

(71) Applicant: KOREA RESEARCH INSTITUTE OF CHEMICAL TECHNOLOGY, Daejeon (KR)

(72) Inventors: U-Hwang Lee, Gyeonggi-do (KR); Jong-San Chang, Dajeon (KR); Sue Kyung Lee, Daejeon (KR); Young Kyu Hwang, Dajeon (KR); Dong Won Hwang, Gyeonggido (KR); Da Hye Jeon, Daejeon (KR); Kyu Eun Shim, Daejeon (KR)

(21) Appl. No.: 14/648,064

(22) PCT Filed: Jan. 18, 2013
(86) PCT No.: PCT/KR2013/000437

§ 371 Date: May 28, 2015

(30) Foreign Application Priority Data
Nov. 30, 2012 (KR) 10-2012-0137689

(51) Int. Cl. C22B 58/00; B01J 20/18; B01J 20/02

(52) U.S. Cl. CPC C22B 58/00; B01J 20/0292; B01J 20/18

(57) ABSTRACT

The present invention relates to a method for recovering indium in a high selectivity and a high efficiency from an indium-containing solution, dispersion or mixture such as seawater, industrial water, waste water, cooling water, a solution extracted from wastes of electronic products such as display panel, or the like.

### TECHNICAL FIELD

The present invention relates to a method of recovering indium from an indium-containing solution, dispersion or mixture, more specifically, a method of recovering indium in a high selectivity and a high efficiency from an indium-containing solution, dispersion or mixture such as sea water, industrial water, waste water, cooling water, a solution extracted from wastes of electronic products such as display panel, or the like.

### BACKGROUND ART

Recently, due to the development of industry and civilization, much concern is now centered on resource acquisition. In order to secure the acquisition of resources such as rare metals used as main raw materials in new growth-engine-industries, Korean government has appointed manganese, molybdenum, lithium, magnesium, titanium, cobalt, chromium, rare earth metals, indium and tungsten as strategic rare metals.

Lithium and uranium are important valuable metals since lithium is employed as raw materials for mobile electronic devices such as mobile phone, notebook PC and camcorder and for a secondary battery which is a power source of hybrid electric vehicles entering in a commercial phase in recent, and uranium is employed as fuel for the nuclear fusion power generation.

In addition, molybdenum is importantly employed in LCD, LED and special steels and magnesium is importantly employed in automobiles, computers or the like. Further, manganese is very importantly employed in the manufacture of special steels for medical instruments, displays, computers or the like. Many other metals are very importantly employed in various fields, for example, cobalt in a secondary battery, etc., tungsten in lighting equipment, special steel, electronic parts, catalysts, etc., titanium in automobile, digital camera, etc., indium in LCD, hybrid vehicle, etc., rare earths in semiconductor, secondary battery, rare earth magnets (permanent magnets), etc., and chromium in medical instruments, display, computer, special steel, etc.

Considering the deficiency of natural resources in Korea, therefore, it can be said that it is important to develop a technology of recovering ten strategic rare metals (manganese, molybdenum, lithium, magnesium, titanium, cobalt, chromium, rare earth metals, indium and tungsten) as well as lithium and uranium as a high value-added resources from seawater or other recycled resources.

In case of seawater resources, such recovery technology may be applied directly to a process of discarding any concentrated salt water obtained during the preparation of prepared salts or directly to thermal effluent seawater discharged from nuclear power plants and thermal power plant after used as cooling water, and thus, the technology is highly economical and is expected to contribute to the environmental protection by relieving the global and seawater warming. Further, such recovery technology is also expected to cause significant economical spreading effects such as the creation of new industries relating to the development of new nano materials for separation and the high-efficient recovery of precious metals and thereby to persue an industry initiative.

Conventional technologies relating to such recovery of precious metals can include the followings.

Korean Registered Patent No. 452526 disclosed a method of treating a waste water for recovering valuable metals characterized in that it comprises a step of selecting a treating manner; a preliminary treatment step to adjust the concentration or pH of input waste water according to the selected treating manner; a first recovery step of valuable metals using barrel type electrolytic device; a second recovery step of valuable metals using a cyclone electrolytic device; and an extraction step of electrolytic water.

### DETAILED DESCRIPTION OF THE INVENTION

### Technical Subject

The present inventors found that indium can be recovered in a high selectivity and a high efficiency from seawater, industrial water, waste water, mine waste water, cooling water or the like by using a metal-phosphate or nonmetal phosphate compound as adsorbent, and thus completed the present invention.

Therefore, the object of the present invention is to provide a method of separating and recovering indium in a high selectivity and a high efficiency from an indium-containing solution, dispersion or mixture such as seawater, industrial water, waste water, cooling water, a solution extracted from electronic wastes such as display panel, or the like.

### Means for Achieving the Subject

In order to achieve the above purpose, the present invention provides a method of recovering indium from an indium-containing solution, dispersion or mixture by employing a metal-phosphate or nonmetal-phosphate compound.

In an embodiment of the present invention, it is preferable to recover indium by introducing a metal-phosphate or nonmetal-phosphate compound into an indium-containing solution or mixture and then stirring or standing for a sufficient time the resulting solution or mixture so that the metal-phosphate or nonmetal-phosphate compound can adsorb indium from the indium-containing solution or mixture.

The indium-containing solution or mixture in the present invention can further comprise at least one selected from a transition metal, a typical metal and lanthanide metal, especially manganese, molybdenum, lithium, magnesium, cobalt, chromium, rare earth metals, tungsten or the like.

### Effect of the Invention

According to the present invention, it is possible to recover and separate indium in a high selectivity and a high efficiency from an indium-containing solution, dispersion or mixture such as seawater, industrial water, waste water, cooling water, a solution extracted from electronic products wastes such as display panel or the like.

### BRIEF DESCRIPTION OF THE DRAWINGS

FIG. 1 is an XRD diffraction pattern of a porous nickel-phosphate molecular sieve prepared in Preparation Example 1 of the present invention.

FIG. 2 is an XRD diffraction pattern of a porous nickel-phosphate molecular sieve prepared in Preparation Example 2 of the present invention.

FIG. 3 is XRD diffraction patterns of the porous nickel-phosphate molecular sieves which have been filtered, dried and then measured during the analysis of the maximum adsorption capability in Test Example 2 of the present invention.

FIG. 4 is a graph showing a time to reach a maximum indium adsorption rate of a porous nickel-phosphate molecular sieve, wherein the rates of adsorbing indium from an indium-containing solution are measured during the adsorption experiment in Test Example 3.

FIG. 5 is a graph showing the indium adsorption velocity of porous nickel-phosphate molecular sieves, wherein the rates of adsorbing indium from an indium-containing solution are measured during the adsorption experiment in Test Example 5.

### EMBODIMENTS FOR CARRYING OUT THE INVENTION

In below, the method of recovering indium according to the present invention is specifically described.

The present invention provides a method of recovering indium from an indium-containing solution or mixture by employing a metal-phosphate or nonmetal-phosphate compound represented by Formula 1:

Ma(PO)bXc [Formula 1]

(wherein, M represents at least one metal or nonmetal selected from a group consisting of nickel (Ni), titanium (Ti), vanadium (Vd), chromium (Cr), manganese (Mn), iron (Fe), cobalt (Co), zinc (Zn), silicone (Si), magnesium (Mg), lanthanide (La), cerium (Ce) and aluminum (Al),

PO represents at least one phosphate ion composed of HPO₄ or PO₄,

X represent at least one coodinatable ion or compoun selected from a group consisting of NH₃, H₂0, hydroxyl (—OH), halogen (F, Cl, Br, I), nitro (—NO₃) and sulphonic acid group (—SO₃H),

a represents a number between 0.01 and 20,

b represents a number between 1 and 60, and

c represents a number between 0 and 40).

In the present invention, the term of indium-containing solution or mixture means a solution, dispersion, mixture or the like in which indium is contained, for example, seawater, industrial water, waste water, cooling water, a solution extracted from electronic waste products such as display panel or the like in which indium is contained, but is not limited thereto.

The above indium-containing solution or mixture can additionally contain other metals such as transition metals, typical metals and lanthanide metals, specifically precious metals such as manganese, molybdenum, lithium, magnesium, titanium, cobalt, chromium, rare-earth elements, tungsten, or the like.

In the present invention, it is possible to employ an indium-containing solution or mixture which contains indium in a concentration of a few or several ppb or more, since the detecting limit of indium in an indium-containing solution or mixture is a level of a few or several ppb (parts per billion).

The metal-phosphate or nonmetal-phosphate compounds employed as an adsorbent for the adsorption of indium in the present invention can mean materials such as a molecular sieve of metal or nonmetal with phosphor composed of metal-phosphate or nonmetal-phosphate bonds represented by the above Formula 1.

In the present invention, metal-phosphate or nonmetal-phosphate compounds as an indium adsorbent may adsorb indium, based on the weight of said compound, in a ratio of 0.1% by weight or more, preferably 0.2% by weight or more, more preferably 0.3% by weight or more, most preferably 0.4% by weight or more.

As a preferred examples of such metal-phosphate compounds, mention can be made to a porous metal-phosphate molecular sieve, for example, VSB series materials such as Ni₁₈(HPO₄)₁₄(OH)₃F₉(H₃O/NH₄)₄. 12H₂O (VSB-1), Ni₂₀[(OH)₁₂(H₂O)₆][(HPO₄)₈(PO₄)₄]. 12H₂O (VSB-5) or the like. In addition, VSB materials also include materials wherein nickel is substituted with other metal elements, for example, such as titanium (Ti), vanadium (Vd), chromium (Cr), manganese (Mn), iron (Fe), cobalt (Co), zinc (Zn), silicon (Si), magnesium (Mg), lanthanide (La) and cerium (Ce), and for example, mention can be made to materials disclosed in Korean Registration Patent No. 0680889.

In one embodiment of the present invention, Ni₂₀[(OH)₁₂(H₂O)₆][(HPO₄)₈(PO₄)₄]. 12H₂O (VSB-5) which can be used as an indium adsorbent in the present invention is a nanopore material (24-membered ring structure) of nickel and phosphor which is composed of 24 oxygen atoms at the entrance of the pore and has a pore size of about 6.4 Å, and for example, mention can be made to VSB-5 disclosed in Korean Registered Patent No. 10-0525209.

As the synthetic method of said VSB-5, a synthetic method composed of adding a base such as diamines covering from 1,2-ethylenediamine to 1,8-octanediamine to nickel and phosphor compounds is known [see: J. Am. Chem. Soc., vol. 125, pp. 1309 1312, 2003; Angew. Chem. Int. Ed. vol. 40, pp. 2831-2834, 2001]. In the said synthetic method, 1,3-diaminopropane (DAP) is mainly employed as the base such as diamines and a reaction mixture will have a composition of 1.0 Ni:2.1 P:5.0 DAP:140 H₂O approximately. The reaction mixture having the above composition is subjected to a hydrothermal reaction at 180° C. for 56 days to give a VSB-5 molecular sieve. However, there are problems that the diamines employed as a base are expensive, that after the synthesis a heat treatment is needed to remove the diamines, and that a part of pore structure will be destroyed or closed during the heat treatment to reduce the surface area of VSB-5 molecular sieve, thereby to cause a reduction of the efficiency when applied.

The above document (Korean Registered Patent No. 10-0525209) also disclosed another synthetic method of said VSB-5, wherein a composition for VSB-5 molecular sieve comprises a nickel compound and a phosphor compound as raw material and a base as a pH adjusting material, and a suitable amount of a specific metal is added to said composition to give a new VSB-5 molecular sieve containing metals, which can possess an oxidation-reduction feature, a light feature and an electric and electronic feature, which are different from any existing VSB-5 molecular sieve. In this method, it is possible to expand the range of the base even to inorganic bases or organic amines such as monoalkylamine. Further, since a thermal treatment can be omitted when using an inorganic base, it is possible to simplify the synthetic process.

In a preferred embodiment of the present invention, porous nickel-phosphate molecular sieves prepared according to the above methods can be used as an adsorbent in order to adsorb indium, and other porous nickel-phosphate molecular sieves prepared according to other methods can also be employed.

When the above porous nickel-phosphate compound is employed as an indium adsorbent in the method of recovering indium according to the present invention, it is possible to adsorb preferably 80% or more, more preferably 90% or more, most preferably 99% or more of indium from a solution or mixture containing indium. The above amazing effects can be supported by below Test Example 4.

According to one preferred embodiment, the above porous nickel-phosphate molecular sieve as an indium adsorbent can adsorb indium in an amount of, based on the weight of molecular sieve, 1% by weight or more, preferably 5% by weight or more, more preferably 10% by weight or more, most preferably 20% by weight or more. In the present invention, some porous nickel-phosphate molecular sieves can adsorb substantially all of indium from an indium-containing solution, specifically to the level of below ppb unit, which is the detection limit.

In the present invention, the metal-phosphate or nonmetal-phosphate compound can be introduced in an amount of 0.1˜150 g, preferably 0.5˜100 g, specifically 1˜80 g per 1 l of a solution or mixture containing indium, but the amount is not limited to the above range and can be adjusted according to adsorbing temperature, stirring rate, adsorbing time or the like. Specifically, the time for adsorbing indium can be reduced when the employed amount and/or stirring rate of metal-phosphate or nonmetal-phosphate compound are increased. Therefore, the employed amount and/or stirring rate can be controlled if necessary.

The process of recovering indium from an indium-containing solution or mixture by employing metal-phosphate or nonmetal-phosphate compound according to the present invention can be carried out according to a process known to a person in this art without a limitation of continuous type, batch type or the like.

The present invention is not limited to the examples described below, and it is obvious to a person having ordinary skill in the art that various modifications and alternatives can be made without departing from the spirit and scope of the present invention. Thus, examples of such modification or alternatives fall within the scope of the present invention.

### EXAMPLES

### Preparation Example 1

### Preparation of a Porous Nickel-Phosphate Molecular Sieve

The preparation of a porous nickel-phosphate molecular sieve composed of nickel, phosphorous, oxygen and metal components is described as follows:

Nickel chloride hexahydrate (NiCl₂.6H₂O) 3.42 g is dissolved in distilled water 24.7 g. To said mixed solution, phosphoric acid 85% solution 1.01 g is added dropwise and then ammoniac water 2.55 g is added to obtain a reactant mixture having a composition of 1 Ni:0.63 P:3.0 NH₃:100.0 H₂O (mol ratio) and pH of 7.7. The above obtained reaction mixture 30 g is introduced in a Teflon reactor, sealed and maintained in a microwave reactor at 180° C. for 1 hour to carry out a crystallization. The resulting reaction mixture is cooled at 25° C. and subjected to a solid-liquid separation to give VSB-5 molecular sieve.

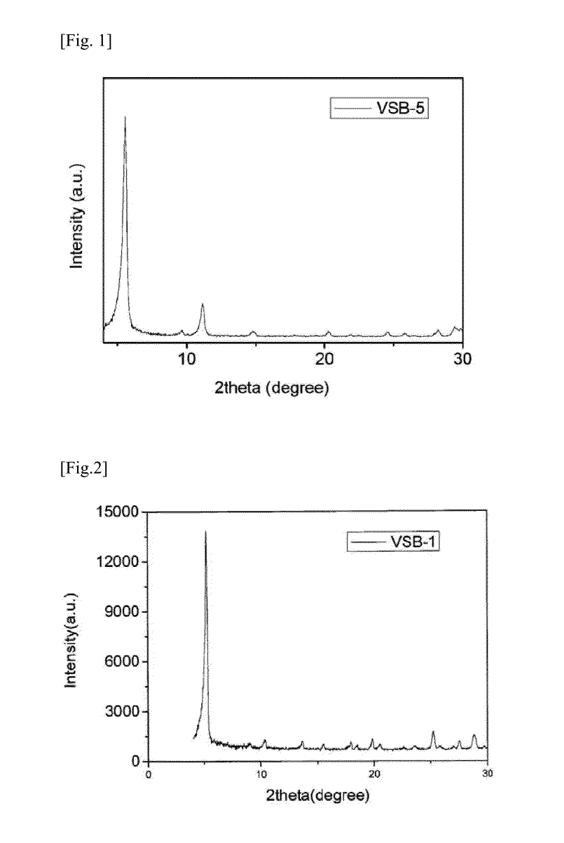

Thus obtained VSB-5 molecular sieve shows a BET surface area of 400 m²/g and its XRD refraction analysis shows that it has the same structure as described in Korean Patent Publication No. 10-0525209. The resulting XRD refraction pattern is shown in FIG. 1.

### Preparation Example 2

### Preparation of a Porous Nickel-Phosphate Molecular Sieve

Nickel chloride hexahydrate (NiCl₂.6H₂O) 3.30 g is dissolved in distilled water 23.86 g. To said mixed solution, phosphoric acid 85% solution 1.6 g is added dropwise and ammonium fluoride 1.28 g is added to obtain a reactant mixture having a composition of 1.00 Ni:1.00 P:2.5 NH₄F:100 H₂O (molar ratio). The above obtained reaction mixture 30 g is introduced in a Teflon reactor, sealed and maintained in a microwave reactor at 180° C. for 1 hour to carry out a crystallization. The resulting reaction mixture is cooled at 25° C. and subjected to a solid-liquid separation to give VSB-1 molecular sieve.

XRD refraction analysis of thus obtained VSB-1 molecular sieve shows that it has the same structure as described in Korean Patent Publication No. 10-0525209. The resulting XRD refraction pattern is shown in FIG. 2.

### Preparation Example 3

### Preparation of porous aluminophosphate-5 (AlPO-5)

Aluminum hydroxide ((pseudo-boehmite phase, 74.2 wt % Al₂O₃, 25.8 wt % H₂O) 27.5 g and phosphoric acid (85%) 46.1 g are introduced in distilled water 100 g and stirred for 2 hours. Thereto, 23 wt % TPAOH(tetrapropylammonium hydroxide) 176.8 g as a structure-directing agent is slowly dropped and stirred for 2 hours to obtain a homogeneous phase. Thus obtained solution has a composition of Al₂O₃:P₂O₅:0.5 (TPA)₂O:73 H₂O (mol ratio).

Thus prepared mother liquid 30 ml is introduced into an autoclave, sealed and placed in an oven at 150° C. for 48 hours. The resulting mixture is filtered and washed with an excess amount of deionized water, and then calcinated at 550° C. for 5 hours to remove the organic structure-directing agent present at its pore and surface to obtain AlPO-5 molecular sieve.

XRD refraction analysis of thus obtained AlPO-5 molecular sieve shows that it has the same structure as described in U.S. Pat. No. 4,310,440.

### Preparation Example 4

### Preparation of Porous Silicoaluminophosphate-5 (SAPO-5)

Tetraethylammonium hydroxide (TEAOH, 35%) 20.0 g is added to aluminum isopropoxide (98%) 19.9 g. Thereafter, phosphoric acid (85%) 11.0 g and water 43 ml are slowly dropped for 2 hours under stirring into the above aluminum isopropoxide solution and the resulting mixture is sufficiently stirred further for 1.5˜5 hours to obtain an aluminum phosphate solution

Separately, fumed silica (99.9%) 0.86 g is added to diethylamine (DEA, 99.5%) 3.51 g and completely dissolved by stirring at room temperature (20° C.) for 2 hours.

Thus prepared silica solution is added to the above aluminum phosphate solution and stirred for 1˜5 hours. Thus obtained reaction gel has the composition of 1.0 Al₂O₃:1.0 P₂O₆:0.3SiO₂:1.0 DEA:1.0 TEAOH:50 H₂O (mol ratio). The above solution in a gel state is introduced in an autoclave and heated at 200° C. for about 7 hours under stirring to obtain SAPO-5 molecular sieve.

In order to separate unreacted materials and obtain the crystalline portion of SAPO-5 molecular sieve, the above obtained SAPO-5 molecular sieve is separated with a centrifuge and washed with water several times.

The above obtained SAPO-5 molecular sieve is dried at 110° C. to give powder, which is sufficiently calcinated for 10 hours with air-blowing to remove structure-directing agents.

XRD refraction analysis of the resulting SAPO-5 molecular sieve shows that it has the same structure as described in a document [S. H. Jhung et al./Microporous and Mesoporous Materials 64 (2003) 3339].

### Example 1

### Recovery of Indium from an Indium-Containing Waste Solution by Employing Nickel-Phosphate Molecular Sieve

VSB-5 molecular sieve 0.2 g, which is the porous nickel-phosphate molecular sieve prepared in the above Preparation Example 1 or 2, is introduced in an indium-containing waste solution 20 ml and stirred for 24 hours or longer to make indium adsorbed into the molecular sieve. A sample solution is taken and subjected to an elemental analysis.

After the adsorption is ended, the porous nickel-phosphate molecular sieve is filtered and analyzed by an elemental analysis to measure the adsorption capability of precious metals.

As an indium-containing waste solution, employed is an ITO etching waste solution which is generated during an etching process wherein an ITO thin-layer as a transparent electrode is sputtered on a glass and then etched to form a pattern by a photo-etching technology (See RIST Research Journal, 2007, Vol. 21, No. 4, pp 352-355, Recovery of acid, indium and tin from ITO etching waste solution).

The indium-containing waste solution employed in this Example 1 has the composition given in Table 1.

TABLE 1

| Element | In | Sn | Si | Al | Ca | Fe |
|---|---|---|---|---|---|---|
| Concen- | 96.8 | 8.85 | 0.8 | 0.19 | 0.15 | 0.15 |
| tration | | | | | | |
| (mg/L) | | | | | | |

After stirring for 24 hours, VSB-5 molecular sieve has adsorbed all of the indium contained in an amount of 96.8 mg/L in the above indium-containing waste solution. More specifically, VSB-5 molecular sieve (0.2 g) has adsorbed all of indium (1.93 mg) contained in 20 ml of the above indium-containing waste solution. Therefore, VSB-5 molecular sieve shows an adsorption capability of 9.68 mg (indium)/1 g (VSB-5) per one adsorption.

The remaining mixture after the adsorption is filtered and dried to recover the molecular sieve, to which an indium waste solution 20 ml having the composition of Table 1 is again added and stirred for 24 hours to carry out a second adsorption experiment. This adsorption process is repeated 5 times and the results are given in Table 2.

TABLE 2

| | Element | | | | |
|---|---|---|---|---|---|
| | Indium (%) | | | | |
| Adsorption time | 1 | 2 | 3 | 4 | 5 |
| Adsorbed amount (%) per | 100 | 100 | 100 | 100 | 100 |
| one adsorption | | | | | |
| cumulative adsorbed | 9.68 | 19.36 | 29.04 | 38.72 | 48.4 |
| amount (mg In/g VSB-5) | | | | | |

As can be seen the above Table 2, the molecular sieve adsorbent has adsorbed all (100%) of indium contained in the indium waster solution 20 ml even after 5-times repeated adsorption experiments. Such results mean that, below the maximum adsorption capability, the adsorbent can be repeatedly utilized without any structural modification of the adsorbent. When repeating the adsorption experiments 5 times by using VSB-5 adsorbent, the cumulative adsorbed amount of indium is measured as 48.4 mg of indium per 1 g of VSB-5.

### Test Example 1

### Evaluation of Maximum Adsorption Capacity of Indium from an Indium-Containing Waste Solution by Employing a Porous Nickel-Phosphate Molecular Sieve

The maximum adsorption capacity of indium per 1 g of a porous nickel-phosphate molecular sieve VSB-5 prepared in Preparation Example 1 is evaluated as follows.

The porous nickel-phosphate molecular sieve VSB-5 0.2 g prepared as above is introduced into each of indium waste solution 200 ml, 300 ml and 500 ml, respectively, stirred for 70 hours or more. Thereafter, the solution is measured on the changes in the indium concentration. The porous nickel-phosphate molecular sieve is filtered, dried and measured with an elemental analysis. The results are shown in Table 3.

Referring to Table 3, an average amount of indium adsorbed to the porous nickel-phosphate molecular sieve is 99 mg Inulg VSB-5, which means the indium adsorption amount per the weight of a porous nickel-phosphate molecular sieve is 9.9 wt %.

TABLE 3

| | Indium adsorbed amount | |
|---|---|---|
| Volume of ITO waste | (In mg/g VSB-5) | Adsorbed amount |
| solution to be added | (the result of powder ICP) | (wt %) |
| 200 ml | 98 | 9.8 |
| 300 ml | 89 | 8.9 |
| 500 ml | 110 | 11.0 |
| Average value | 99 | 9.9 |

### Test Example 2

### Evaluation of Structure Stability after Adsorbing Indium from an Indium-Containing Waste Solution by Employing a Porous Nickel-Phosphate Molecular Sieve

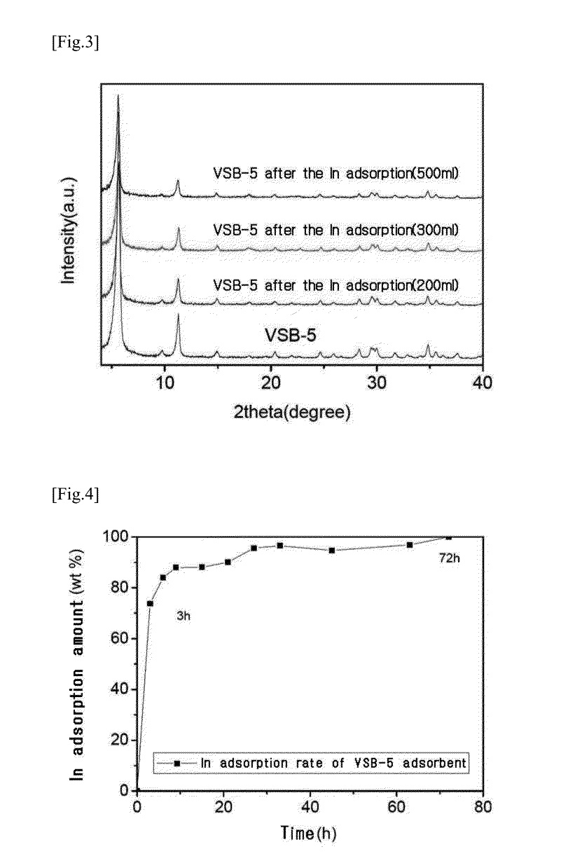

The porous nickel-phosphate molecular sieves subjected to the experiment on the maximum adsorption capability in the above Test Example 1 are filtered, dried and measured with an XRD analysis. The resulting patterns are shown in FIG. 3.

As can be seen from FIG. 3, the porous nickel-phosphate molecular sieves could maintain their crystalline structure after adsorbing indium in an indium-containing solution.

### Test Example 3

### Measurement of Adsorption Velocity of a Porous Nickel-Phosphate Molecular Sieve

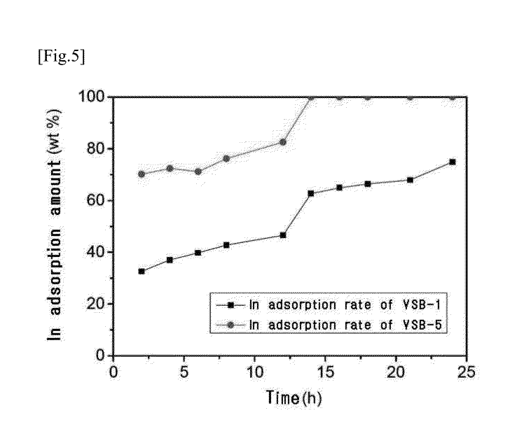

During the adsorption experiment of a porous nickel-phosphate molecular sieves in Test Example 1, solution samples are taken at suitable intervals, filtered and measured with an elemental analysis to confirm a time reach the maximum adsorption. The results are shown in FIG. 4.

As can be seen in FIG. 4, the porous nickel-phosphate molecular sieve used in Test Example 1 shows an indium adsorption amount of 99% or more after 70 hours of the adsorption experiment.

### Test Example 4

### Recovery of Indium from an Artificial Sea Water Solution by Employing a Porous Nickel-Phosphate Molecular Sieve

In order to confirm a selective adsorption feature of a porous nickel-phosphate molecular sieve to selectively adsorb indium from an artificial seawater solution containing one of lithium, indium and cobalt elements, a test was carried out as follows.

To the artificial seawater solution having the composition shown in Table 4, each of LiCl, Co(NO₃)₂.6H₂O and In(NO₃)₃XH₂O is introduced to give Seawater solution 1 containing 5×10⁻³ M of lithium, Seawater solution 2 containing 5×10⁻³ M of indium and Seawater solution 3 containing 5×10⁻³M of cobalt, respectively.

The porous nickel-phosphate molecular sieves VSB-1 or VSB-5 prepared in the above Preparation Examples 1 and 2 are introduced in an amount of 0.2 g into the above prepared artificial seawater solutions 20 ml containing each precious metal and then stirred for 24 hours or more to test the adsorption capability of said precious metals. The adsorbed amount is evaluated by an elemental analysis on the resulted solutions containing lithium, cobalt or indium, respectively, and by an elemental analysis on the resulted porous composite which is filtered and dried after the adsorption experiments. The results are shown in Table 5.

TABLE 4

| Salts | NaCl | MgCl₂ | CaCl₂ | KCl | NaHCO₃ | KBr |
|---|---|---|---|---|---|---|
| Concen- | 24.32 | 5.14 | 1.14 | 0.69 | 0.2 | 0.1 |
| tration | | | | | | |
| (g/L) | | | | | | |
| Salt | H₃BO₃ | SnCl₂ | NH₄Cl | NaF | Na₂SiO₃ | FePO₄ |
| Concen- | 0.027 | 0.06 | 0.0064 | 0.003 | 0.002 | 0.001 |
| tration | | | | | | |
| (g/L) | | | | | | |

TABLE 5

| Metal ions and their concentration | | Adsorbed ratio | Adsorbed ratio |
|---|---|---|---|
| introduced into artificial seawater | | into VSB-1 (%) | into VSB-5 (%) |
| Li | 5*10⁻³ M | 8.7 | 2.8 |
| Co | 5*10⁻³ M | 44.4 | 50 |
| In | 5*10⁻³ M | 100 | 100 |

When referring to Table 5, 8.7% of lithium contained in seawater was adsorbed in the VSB-1 adsorbent and the remaining lithium is not adsorbed and present in the seawater. The VSB-1 adsorbent adsorbed 44.4% of cobalt elements contained in seawater. Although the VSB-1 adsorbent could adsorb only a part of lithium element and cobalt element, the VSB-1 adsorbent could adsorb almost all (99% or more) of indium element.

Meanwhile, a VSB-5 adsorbent adsorbed 2.8% of lithium and 50% of cobalt contained in the seawater, but adsorbed 99% or more of indium contained in the seawater. Therefore, the VSB-5 adsorbent shows a feature that, under the same concentration and same adsorption condition, it can adsorb a part of lithium and cobalt elements but almost all (more than 99%) of indium.

### Test Example 5

### The Velocity of Indium Recovery from an Artificial Sea Water Solution by Employing a Porous Nickel-Phosphate Molecular Sieve

During the adsorption test of a porous nickel-phosphate molecular sieve in Test Example 1, samples are taken, filtered and subjected to an elemental analysis to evaluate the velocity of adsorption of the porous nickel-phosphate molecular sieve. The results are shown in FIG. 5.

As can be seen in FIG. 5, the porous nickel-phosphate molecular sieve shows 87% of indium adsorption rate after 9 hours. At this time, the VSB-5 adsorbent shows an adsorption velocity faster than VSB-1 adsorbent.

### Test Example 6

### Recovery of Indium from Indium Waste Solution by Employing an Aluminiumphosphate Molecular Sieve

A molecular sieve 0.2 g, selected from a porous crystalline aluminum-phosphate or silicoaluminum-phosphate such as AlPO-5 or SAPO-5 molecular sieve prepared at the above Preparation Example 3 or 4, is introduced into an indium waste solution 20 ml and stirred for 24 hours or more to adsorb indium. Sample solutions are taken from the resulting mixture and measured with an elemental analysis.

After the adsorption experiment, the crystalline molecular sieve is filtered, dried and subjected to an elemental analysis to confirm the capability of adsorbing precious metals.

The indium waste solution employed in this Example has the composition described in Table 1.

After stirring for 24 hours, AlPO-5 or SAPO-5 molecular sieve could adsorb a part of the indium contained in an amount of 96.8 mg/L in the above indium-containing waste solution. More specifically, AlPO-5 or SAPO-5 molecular sieve (0.2 g) has adsorb a part of indium contained in an amount of 1.93 mg in 20 ml of the above indium-containing waste solution. Therefore, AlPO-5 and SAPO-5 molecular sieves show an adsorption capability of 2.83 mg/g of AlPO-4 and 4.22 mg/g of SAPO-5, respectively. The results are given in Table 6.

TABLE 6

Analyzed element
Indium

| Adsorbent | AlPO-5 | SAPO-5 |
|---|---|---|
| Adsorbed amount (mg In/g) | 2.83 | 4.22 |

As can be seen the above table 6, the porous nickel-phosphate (VSB-5) molecular sieve of Test Example 1 adsorbed indium in the amount of 9.9 mg per 1 g of the adsorbent, but the aluminium-phosphate (AlPO-5) and silicoaluminium-phosphate (SAPO-5) molecular sieve adsorbed indium in the amount of 2.83 mg and 4.22 mg, respectively, per 1 g of the adsorbent. The absorbent AlPO-5 or SAPO-5 can absorbs indium in an amount less than that of the absorbent VSB-5.

### INDUSTRIAL APPLICABILITY

The recovery method of indium according to the present invention can be advantageously utilized in the manufacturing industries of LCD, LED, hybrid vehicles, mobile phones, etc. in which indium is largely employed.

What is claimed is:

1. Method for recovering indium from a solution or mixture containing indium by using an adsorbent which comprises at Leat one material selected from a metal-phosphate or nonmetal-phosphate compound represented by Formula 1:
Ma(PO)bXc [Formula 1]
(wherein, M represents at least one metal or nonmetal selected from a group consisting of nickel (Ni), titanium (Ti), vanadium (Vd), chromium (Cr), manganese (Mn), iron (Fe), cobalt (Co), zinc (Zn), silicone (Si), magnesium (Mg), lanthanide (La), cerium (Ce) and aluminum (Al),
PO represents at least one phosphate ion composed of HPO₄ or PO₄,
X represent at least one coordinatable ion or compound selected from a group consisting of NH₃, H₂0, hydroxyl (—OH), halogen (F, Cl, Br, I), nitro (—NO₃) and sulfonic acid group (—SO₃H),
a represents a number between 0.01 and 20,
b represents a number between 1 and 60, and
c represents a number between 0 and 40.

2. The method according to claim 1, wherein said metal-phosphate compound is a porous nickel-phosphate molecular sieve.

3. The method according to claim 2, wherein said porous nickel-phosphate molecular sieve is Ni₁₈(HPO₄)₁₄(OH)₃F₉(H₃O/NH₄)₄.12H₂O or Ni₂₀[(OH)₁₂(H₂O)₆][(HPO₄)₈(PO₄)₄].12H₂O.

4. The method according to claim 1, wherein said solution or mixture containing indium further contains at least one metal selected from a group consisting of transition metals, typical metals and lanthanide metals.

5. The method according to claim 4, wherein said solution or mixture containing indium further contains at least one metal selected from a group consisting of manganese, molybdenum, lithium, magnesium, titanium, cobalt, chromium, rare-earth metals and tungsten.
